(19) United States
(12) Patent Application Publication
(10) Pub. No.: US 2025/0061386 A1
(43) Pub. Date: Feb. 20, 2025

(54) ON-DEMAND BOATING APP WITH AI VOICE BOOKING AND ENHANCED FEATURES

(71) Applicant: LaMarco Merciano, SR., Miami, FL (US)

(72) Inventor: LaMarco Merciano, SR., Miami, FL (US)

(21) Appl. No.: 18/788,245

(22) Filed: Jul. 30, 2024

(51) Int. Cl. G06Q 10/02; G06F 40/58; G06Q 30/0282; G06Q 50/12

(52) U.S. Cl. CPC G06Q 10/02; G06F 40/58; G06Q 30/0282; G06Q 50/12

(57) ABSTRACT

The present disclosure provides a method for facilitating on-demand boating experiences. The method includes receiving a user request for a boating experience through an application interface, processing the request using an artificial intelligence (AI) voice booking system capable of interpreting and responding in multiple languages, presenting a selection of available boats based on user-specified activity filters and budget constraints, booking a selected boat and captain for the user, providing navigation assistance to guide the user to a boarding location, including ground navigation and an aerial view of the boat from a dock, and during the boating experience, presenting real-time information including historical facts about a marine ecosystem and a trip progress tracker.

### FIELD OF INVENTION

The present disclosure relates to on-demand boating applications, and more particularly to an on-demand boating application with AI voice booking capabilities and enhanced features for facilitating and enriching boating experiences.

### BACKGROUND

Boating has long been a popular recreational activity, offering individuals and groups the opportunity to enjoy water-based experiences for leisure, sport, or exploration. However, traditional methods of accessing boating experiences have often been limited by factors such as boat ownership, specialized knowledge requirements, and the complexities of planning and executing waterborne activities.

The rise of on-demand services in various sectors has transformed consumer expectations for convenience and accessibility. This shift has created an opportunity to apply similar principles to the boating industry, potentially opening up water-based activities to a broader audience. However, the unique nature of boating presents challenges in adapting on-demand models to this domain.

Language barriers have historically been a significant obstacle in the tourism and recreational activity sectors, including boating. This issue can be particularly pronounced in coastal areas and popular boating destinations that attract international visitors. The ability to effectively communicate across languages is crucial for ensuring safety, understanding instructions, and enhancing the overall experience for participants.

Navigation and logistics pose another set of challenges in the boating context. Unlike land-based transportation, boating requires specialized knowledge of waterways, docking procedures, and maritime regulations. For novice boaters or tourists unfamiliar with a particular area, these factors can be daunting and may discourage participation in boating activities.

Additionally, the boating experience extends beyond the act of being on the water. Aspects such as meal planning, understanding the local marine ecosystem, and tracking the progress of a journey all contribute to the overall enjoyment and educational value of a boating excursion. However, integrating these elements into a cohesive and accessible format has remained a challenge.

Furthermore, the quality and reliability of boating services can vary widely, impacting user satisfaction and safety. Traditional methods of assessing and maintaining service standards in the boating industry have often been informal or inconsistent, leaving room for improvement in ensuring high-quality experiences for all participants.

As technology continues to advance and consumer preferences evolve, there is a growing need for innovative solutions that can address these challenges and enhance the accessibility, safety, and enjoyment of boating experiences for a diverse range of users.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for facilitating on-demand boating experiences is provided. The method includes receiving, by a processing device, a user request for a boating experience through an application interface. The method includes processing the user request using an artificial intelligence (AI) voice booking system capable of interpreting and responding in multiple languages. The method includes presenting, through the application interface, a selection of available boats based on user-specified activity filters and budget constraints. The method includes booking a selected boat and captain for the user. The method includes providing navigation assistance to guide the user to a boarding location, including ground navigation and an aerial view of the boat from a dock. The method includes, during the boating experience, presenting real-time information, including historical facts about a marine ecosystem and a trip progress tracker.

According to other aspects of the present disclosure, the method may include one or more of the following features. The AI voice booking system may be capable of interpreting and responding in at least English, Spanish, French, and Mandarin. The method may further include offering catering services for the boating experience through the application interface. The catering services may include options for dietary-specific meals. The user-specified activity filters may include options for specific types of fishing, water sports, or marine wildlife viewing. The method may further include implementing a two-way rating system allowing users to rate captains and captains to rate users. The two-way rating system may be used to maintain service quality standards and assess user behavior.

According to another aspect of the present disclosure, a system for facilitating on-demand boating experiences is provided. The system includes a processing device and a memory device storing instructions that, when executed by the processing device, cause the system to receive a user request for a boating experience through an application interface. The instructions cause the system to process the user request using an artificial intelligence (AI) voice booking system capable of interpreting and responding in multiple languages. The instructions cause the system to present, through the application interface, a selection of available boats based on user-specified activity filters and budget constraints. The instructions cause the system to book a selected boat and captain for the user. The instructions cause the system to provide navigation assistance to guide the user to a boarding location. The instructions cause the system to, during the boating experience, present real-time information, including a trip progress tracker.

According to other aspects of the present disclosure, the system may include one or more of the following features. The AI voice booking system may be capable of interpreting and responding in at least English, Spanish, French, and Mandarin. The instructions may further cause the system to offer catering services for the boating experience through the application interface. The catering services may include options for dietary-specific meals. The user-specified activity filters may include options for specific types of fishing, water sports, or marine wildlife viewing. The instructions may further cause the system to implement a two-way rating system allowing users to rate captains and captains to rate users. The two-way rating system may be used to maintain service quality standards and assess user behavior.

According to another aspect of the present disclosure, a non-transitory computer-readable medium storing instructions is provided. When executed by a processing device, the instructions cause the processing device to perform a method for facilitating on-demand boating experiences. The method includes receiving a user request for a boating experience through an application interface. The method includes processing the user request using an artificial intelligence (AI) voice booking system. The method includes presenting, through the application interface, a selection of available boats based on user-specified filters. The method includes booking a selected boat and captain for the user. The method includes providing navigation assistance to guide the user to a boarding location. The method includes, during the boating experience, presenting real-time information related to the boating experience.

According to other aspects of the present disclosure, the non-transitory computer-readable medium may include one or more of the following features. The AI voice booking system may be capable of interpreting and responding in at least English, Spanish, French, and Mandarin. The user-specified filters may include activity filters for specific types of boating experiences and budget constraints. The method may further include offering catering services for the boating experience through the application interface. The catering services may include options for dietary-specific meals. The method may further include implementing a two-way rating system allowing users to rate captains and captains to rate users, wherein the two-way rating system is used to maintain service quality standards and assess user behavior.

The foregoing general description of the illustrative embodiments and the following detailed description thereof are merely exemplary aspects of the teachings of this disclosure and are not restrictive.

### BRIEF DESCRIPTION OF FIGURES

FIG. 1 illustrates a system diagram of a customer portion of an on-demand boating experience platform, according to aspects of the present disclosure.

FIG. 2 illustrates a system diagram of another aspect of the customer portion of the on-demand boating experience platform, according to aspects of the present disclosure.

FIG. 3 illustrates a system diagram of another aspect of the customer portion of the on-demand boating experience platform, according to aspects of the present disclosure.

FIG. 4 illustrates a system diagram of a captain portion of the on-demand boating experience platform, according to aspects of the present disclosure.

### DETAILED DESCRIPTION

The present disclosure provides a method and system for facilitating on-demand boating experiences through a comprehensive application interface. This interface may incorporate an artificial intelligence (AI) voice booking system capable of interpreting and responding in multiple languages, thereby addressing language barriers and enhancing accessibility for a diverse range of users. The application interface may also present a selection of available boats based on user-specified activity filters and budget constraints, offering a tailored and user-friendly booking process.

In addition to facilitating the booking process, the disclosed method and system may provide navigation assistance to guide the user to a boarding location. This assistance may include ground navigation and an aerial view of the boat from a dock, thereby addressing challenges associated with maritime navigation and logistics.

Furthermore, the disclosed method and system may enhance the overall boating experience by presenting real-time information during the boating experience. This information may include historical facts about a marine ecosystem and a trip progress tracker, adding educational value and engagement to the boating excursion.

The disclosed method and system may also implement a two-way rating system allowing users to rate captains and captains to rate users. This feature may promote accountability, maintain service quality standards, and assess user behavior, thereby addressing issues related to service quality and reliability in the boating industry.

In summary, the present disclosure provides a method and system that leverages advanced technology to streamline the boat rental process, enhance user engagement, and improve the overall boating experience. This approach may address various challenges in the boating industry and make boating more accessible, convenient, and enjoyable for a wider audience.

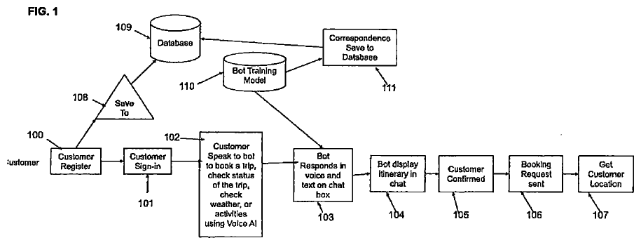

Referring to FIG. 1, the initial user interaction with the on-demand boating experience platform may begin with a customer registration 100. In some cases, the customer registration 100 may involve the user creating an account or profile on the platform, providing necessary details such as name, contact information, and preferences. Following the customer registration 100, the user may proceed to a customer sign 101, which may involve the user logging into their account on the platform.

Once the user has successfully signed in, they may interact with the platform through a customer dictation 102. In some aspects, the customer dictation 102 may involve the user providing voice commands or queries to the platform. These voice commands or queries may be related to booking a boating experience, checking the status of a trip, inquiring about weather conditions, or exploring available activities.

The platform may process these voice commands or queries using an artificial intelligence (AI) voice booking system, represented by a bot response 103. The bot response 103 may be capable of interpreting and responding in multiple languages, enhancing the accessibility of the platform for a diverse range of users. In some cases, the AI voice booking system may support languages such as English, Spanish, French, and Mandarin, allowing users to hear and read their itinerary, receive voice-to-text responses, and confirm bookings in their preferred language.

The bot response 103 may be connected to a customer bot training model 110, which may contain the AI algorithms and data used to train the bot for responses and interactions. The customer bot training model 110 may be designed to continuously learn and improve from each interaction, enhancing the accuracy and efficiency of the bot response 103 over time.

Following the bot's response, the system may display the itinerary in the chat interface through an itinerary displayed 104. The itinerary displayed 104 may provide a visual representation of the user's planned boating experience, including details such as the selected boat, captain, departure time, and planned activities. The user may then confirm the booking via a customer confirmed 105, which may involve the user providing a voice or text confirmation to finalize the booking.

In some aspects, the platform may send a booking request 106 to the selected captain and retrieve the customer's location 107 for navigation purposes and to provide location-specific information. The customer's interactions and the bot's responses may be saved to a database 109 via a save to function 108 and a correspondance save to database 111, providing a record of the booking process and facilitating future system improvements.

Further referring to FIG. 1, the customer dictation 102 may be a key component of the user interaction with the platform. In some aspects, the customer dictation 102 may involve the user providing voice commands or queries to the platform. These voice commands or queries may be related to booking a boating experience, checking the status of a trip, inquiring about weather conditions, or exploring available activities. The customer dictation 102 may be designed to accept and process voice inputs in multiple languages, enhancing the accessibility of the platform for a diverse range of users.

The platform may process these voice commands or queries using an artificial intelligence (AI) voice booking system, represented by a bot response 103. The bot response 103 may be capable of interpreting and responding in multiple languages, enhancing the accessibility of the platform for a diverse range of users. In some cases, the AI voice booking system may support languages such as English, Spanish, French, and Mandarin, allowing users to hear and read their itinerary, receive voice-to-text responses, and confirm bookings in their preferred language.

The bot response 103 may be connected to a customer bot training model 110, which may contain the AI algorithms and data used to train the bot for responses and interactions. The customer bot training model 110 may be designed to continuously learn and improve from each interaction, enhancing the accuracy and efficiency of the bot response 103 over time. The customer bot training model 110 may be stored in a memory device and executed by a processing device, enabling the platform to adapt and improve its responses based on past interactions.

Following the bot's response, the system may display the itinerary in the chat interface through an itinerary displayed 104. The itinerary displayed 104 may provide a visual representation of the user's planned boating experience, including details such as the selected boat, captain, departure time, and planned activities. The user may then confirm the booking via a customer confirmed 105, which may involve the user providing a voice or text confirmation to finalize the booking.

In some aspects, the platform may send a booking request 106 to the selected captain and retrieve the customer's location 107 for navigation purposes and to provide location-specific information. The customer's interactions and the bot's responses may be saved to a database 109 via a save to function 108 and a correspondance save to database 111, providing a record of the booking process and facilitating future system improvements.

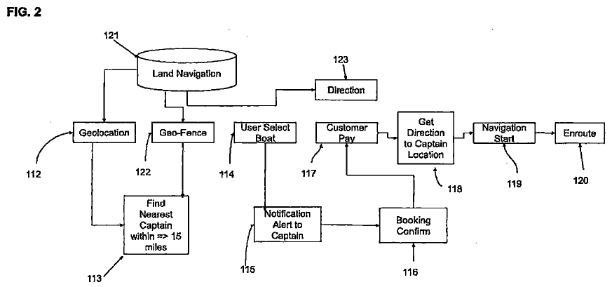

Referring to FIG. 2, the system may present a selection of available boats based on user-specified activity filters and budget constraints through a boat selection interface 114. In some aspects, the boat selection interface 114 may display a list or gallery of available boats, each with detailed information such as size, capacity, amenities, and rental price. The user may filter this selection based on their preferred activities, such as fishing, water sports, or marine wildlife viewing, and their budget constraints. This feature may allow users to find boats that precisely match their needs and preferences, improving user satisfaction and reducing the time spent searching.

Once the user has selected a boat, the system may book the selected boat and captain for the user through a booking confirmation module 116. In some cases, the booking confirmation module 116 may send a booking request to the selected captain, confirm the availability of the boat for the chosen date and time, and finalize the booking upon the captain's acceptance. This process may be automated and streamlined, reducing the need for manual coordination and communication between the user and the captain.

Following the booking confirmation, the system may provide navigation assistance to guide the user to the boarding location. This assistance may be facilitated by a geolocation module 112, a direction module 123, and a captain location direction module 118. The geolocation module 112 may determine the user's current location, while the direction module 123 may generate a route from the user's location to the boarding location. The captain location direction module 118 may then guide the user along this route, providing turn-by-turn directions and real-time updates as needed.

In some aspects, the navigation assistance may include an aerial view of the boat from the dock, providing the user with a visual reference for their destination. This aerial view may be stored in an aerial view data store 136 and displayed to the user through the application interface. The aerial view may provide a bird's-eye perspective of the boat and its surroundings, helping the user to orient themselves and locate the boat more easily.

In some aspects, the system may provide an aerial view of the boat from the dock as part of the navigation assistance. This feature may provide the user with a visual reference for their destination, helping them to locate the boat more easily. The aerial view may be generated using satellite imagery or drone footage, and may include markers or annotations to highlight the boat and other points of interest. This feature may enhance the user's navigation experience, making it easier and more intuitive to find their way to the boat.

In some cases, the user-specified activity filters may include options for specific types of fishing, water sports, or marine wildlife viewing. For example, users may filter for boats that are equipped for deep-sea fishing, jet skiing, or whale watching. This feature may allow users to tailor their boating experience to their specific interests and activities, enhancing the overall enjoyment and satisfaction of the experience.

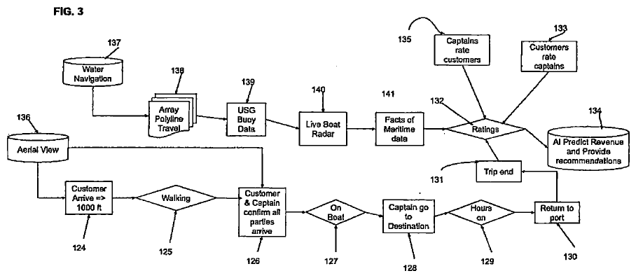

Referring to FIG. 3, the system may present real-time information during the boating experience. This information may include historical facts about a marine ecosystem and a trip progress tracker, adding educational value and engagement to the boating excursion. The real-time information may be provided through a maritime facts module 141, which may access a database of historical and ecological data related to the marine environment. In some aspects, the maritime facts module 141 may present this information in an interactive format, such as pop-up notifications or audio narrations, enhancing the user's learning experience.

The trip progress tracker may be facilitated by an hours on water tracker 129, which may monitor the duration of the boating experience and provide real-time updates on the remaining time. The hours on water tracker 129 may also trigger a return to port trigger 130 when the boating experience is nearing its end, guiding the user back to the dock and ensuring a timely return.

Upon completion of the boating experience, the system may implement a two-way rating system allowing users to rate captains and captains to rate users. This feature may be facilitated by a rating submission interface 132, which may present rating scales or forms to the user and the captain. The user may provide their rating through a customer rating input 133, while the captain may provide their rating through a captain rating input 135. This two-way rating system may promote accountability, maintain service quality standards, and assess user behavior, thereby addressing issues related to service quality and reliability in the boating industry.

In some cases, the system may also incorporate a revenue prediction module 134, which may use data from various parts of the system to generate insights and suggestions. The revenue prediction module 134 may analyze data such as booking rates, user ratings, and trip durations to predict future revenue trends and provide recommendations for improving business performance. This feature may provide valuable insights for boat owners and captains, helping them to optimize their operations and maximize their revenue.

In some aspects, the system may provide an aerial view of the boat from the dock or general port vicinity as part of the navigation assistance. This feature may be facilitated by an aerial view data store 136, which may store aerial imagery of the boat and its surroundings. The aerial view may provide a bird's-eye perspective of the boat and the dock, helping the user to orient themselves and locate the boat more easily. This feature may enhance the user's navigation experience, making it easier and more intuitive to find their way to the boat.

In some cases, the system may also provide a live boat radar 140, which may display real-time information about other boats in the vicinity. The live boat radar 140 may help the user to navigate safely and avoid collisions, enhancing the safety and convenience of the boating experience. The live boat radar 140 may be particularly useful in busy waterways or during poor visibility conditions, providing an additional layer of navigation assistance for the user.

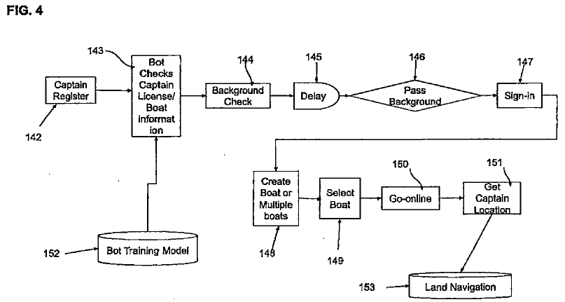

Referring to FIG. 4, the system may also facilitate a captain registration and boat listing process. This process may begin with a captain registration 142, which may involve the captain creating an account or profile on the platform, providing necessary details such as name, contact information, and boating credentials. Following the captain registration 142, the system may proceed to a captain license and boat information check 143. In some cases, the captain license and boat information check 143 may involve verifying the captain's license and boat information against a database or registry. This verification process may be automated and facilitated by a captain bot training model 152, which may contain the AI algorithms and data used to verify the provided information.

After the captain license and boat information check 143, the system may conduct a background check 144. The background check 144 may involve verifying the captain's criminal record, driving record, or other relevant background information. This step may help ensure the safety and reliability of the captains available on the platform. Following a delay 145, which may be necessary to process the background check, the system may proceed to a pass background check 146 step. If the background check is passed, the captain may proceed to a captain sign-in 147 step, logging into their account on the platform.

Once the captain has successfully signed in, they may proceed to a create boat profile(s) 148 step. In some aspects, the create boat profile(s) 148 step may involve the captain providing detailed information about their boat or boats, such as size, capacity, amenities, and rental price. This information may be displayed to users through the boat selection interface 114, helping users to find boats that match their needs and preferences.

Following the creation of the boat profile(s), the captain may proceed to a select boat 149 step, choosing which boat or boats to list as available for bookings. The system may then list the selected boat or boats online through a list boat online 150 step, making them visible to users on the platform.

Finally, the system may retrieve the captain's location through a retrieve captain location 151 step. This step may involve determining the captain's current location using GPS or other location services, and storing this information in a captain land navigation data store 153. The captain's location may be used to provide navigation assistance to users, guiding them to the boarding location.

In some cases, the captain registration and boat listing process may include additional steps or variations. For example, the captain bot training model 152 may be updated or retrained periodically to improve the accuracy and efficiency of the captain license and boat information check 143. Similarly, the background check 144 may include additional checks or verifications, such as checking the captain's credit history or professional references. The create boat profile(s) 148 step may also include options for the captain to upload photos or videos of their boat, provide a detailed description of the boat's features and amenities, or specify any rules or restrictions for the boat's use. These variations may enhance the functionality and user-friendliness of the platform, providing a more comprehensive and tailored boating experience for users.

In some aspects, the on-demand boating experience platform may offer catering services for the boating experience through the application interface. The catering services may be designed to enhance the user experience by providing a range of meal options that can be enjoyed during the boating excursion. In some cases, the catering services may include options for breakfast, lunch, dinner, or snacks, and may cater to various dietary preferences and restrictions.

The catering services may be facilitated by a catering services module (not shown), which may be integrated into the application interface. The catering services module may present a menu or list of available meal options to the user, allowing the user to select their preferred meals and add them to their booking. In some cases, the catering services module may also provide detailed information about each meal option, such as ingredients, nutritional information, and preparation methods, helping users to make informed choices based on their dietary needs and preferences.

In some aspects, the catering services may include options for dietary-specific meals. For example, the catering services module may offer vegetarian, vegan, gluten-free, or kosher meals, catering to users with specific dietary restrictions or preferences. This feature may enhance the inclusivity and accessibility of the platform, making it suitable for a diverse range of users.

In some cases, the catering services may be provided by a network of partner restaurants or caterers. The platform may integrate with these partners through an API or other interface, allowing users to access a wide range of meal options from various cuisines and culinary traditions. This feature may enhance the variety and quality of the catering services, providing a gourmet dining experience on the water.

In some aspects, the catering services may be customizable based on the user's preferences. For example, the user may be able to specify their preferred meal times, portion sizes, or food preferences, and the catering services module may tailor the meal options accordingly. This feature may enhance the personalization and flexibility of the catering services, providing a tailored dining experience for each user.

In some cases, the catering services may also include options for beverages, such as soft drinks, coffee, tea, or alcoholic beverages. The platform will comply with local laws and regulations regarding the sale and consumption of alcoholic beverages, ensuring a safe and responsible boating experience.

In summary, the catering services offered through the application interface may enhance the user experience by providing a range of meal options that cater to various dietary preferences and restrictions. This feature may add convenience and enjoyment to the boating experience, allowing users to focus on their activities and enjoy their time on the water.

1. A method for facilitating on-demand boating experiences, comprising:
receiving, by a processing device, a user request for a boating experience through an application interface;
processing the user request using an artificial intelligence (AI) voice booking system capable of interpreting and responding in multiple languages;
presenting, through the application interface, a selection of available boats based on user-specified filters;
booking a selected boat and captain for the user;
providing navigation assistance to guide the user to a boarding location; and
during the boating experience, presenting real-time information related to the boating experience.

2. The method of claim 1, wherein the AI voice booking system is capable of interpreting and responding in at least English, Spanish, French, and Mandarin.

3. The method of claim 1, wherein the user-specified filters include activity filters for specific types of boating experiences and budget constraints.

4. The method of claim 1, further comprising offering catering services for the boating experience through the application interface.

5. The method of claim 4, wherein the catering services include options for dietary-specific meals.

6. The method of claim 1, wherein providing navigation assistance includes presenting ground navigation directions and an aerial view of the boat from a dock.

7. The method of claim 1, further comprising implementing a two-way rating system allowing users to rate captains and captains to rate users, wherein the two-way rating system is used to maintain service quality standards and assess user behavior.

8. A system for facilitating on-demand boating experiences, comprising:
a processing device;
a memory device storing instructions that, when executed by the processing device, cause the system to:
receive a user request for a boating experience through an application interface;
process the user request using an artificial intelligence (AI) voice booking system capable of interpreting and responding in multiple languages;
present, through the application interface, a selection of available boats based on user-specified filters;
book a selected boat and captain for the user;
provide navigation assistance to guide the user to a boarding location; and
during the boating experience, present real-time information related to the boating experience.

9. The system of claim 8, wherein the AI voice booking system is capable of interpreting and responding in at least English, Spanish, French, and Mandarin.

10. The system of claim 8, wherein the user-specified filters include activity filters for specific types of boating experiences and budget constraints.

11. The system of claim 8, wherein the instructions further cause the system to offer catering services for the boating experience through the application interface.

12. The system of claim 11, wherein the catering services include options for dietary-specific meals.

13. The system of claim 8, wherein providing navigation assistance includes presenting ground navigation directions and an aerial view of the boat from a dock.

14. The system of claim 8, wherein the instructions further cause the system to implement a two-way rating system allowing users to rate captains and captains to rate users, wherein the two-way rating system is used to maintain service quality standards and assess user behavior.

15. A non-transitory computer-readable medium storing instructions that, when executed by a processing device, cause the processing device to perform a method for facilitating on-demand boating experiences, the method comprising:
receiving a user request for a boating experience through an application interface;
processing the user request using an artificial intelligence (AI) voice booking system;
presenting, through the application interface, a selection of available boats based on user-specified filters;
booking a selected boat and captain for the user;
providing navigation assistance to guide the user to a boarding location; and
during the boating experience, presenting real-time information related to the boating experience.

16. The non-transitory computer-readable medium of claim 15, wherein the AI voice booking system is capable of interpreting and responding in at least English, Spanish, French, and Mandarin.

17. The non-transitory computer-readable medium of claim 15, wherein the user-specified filters include activity filters for specific types of boating experiences and budget constraints.

18. The non-transitory computer-readable medium of claim 15, wherein the method further comprises offering catering services for the boating experience through the application interface.

19. The non-transitory computer-readable medium of claim 18, wherein the catering services include options for dietary-specific meals.

20. The non-transitory computer-readable medium of claim 15, wherein providing navigation assistance includes presenting ground navigation directions and an aerial view of the boat from a dock.
